(19) United States
(12) Patent Application Publication
(10) Pub. No.: US 2024/0388882 A1
(43) Pub. Date: Nov. 21, 2024

(54) Method And Apparatus For Enhancements Of Manual Network Selection In Emergency Services Handling

(71) Applicant: MediaTek Singapore Pte. Ltd., Singapore (SG)

(72) Inventors: Puneet Puneet, Bengaluru KA (IN); Marko Niemi, Oulu (FI); Yuan-Chieh Lin, Hsinchu City (TW); Yu-Hsin Lin, Hsinchu City (TW)

(21) Appl. No.: 18/661,688

(22) Filed: May 12, 2024

(30) Foreign Application Priority Data
May 15, 2023 (IN) 202321034104

(51) Int. Cl. H04W 4/90; H04W 36/00; H04W 84/04

(52) U.S. Cl. CPC H04W 4/90; H04W 36/00222; H04W 84/042

(57) ABSTRACT

Various solutions for enhancements of manual network selection in emergency services handling are described. An apparatus may determine whether it is in a condition of having the ongoing emergency service or attempting to obtain emergency services before an association between the apparatus and a core network of a wireless network for the emergency services is established. The apparatus may determine not to perform a manual network selection in an event that the apparatus is in the condition of having the ongoing emergency service or attempting to obtain the emergency services before the association between the apparatus and the core network is established.

### CROSS REFERENCE TO RELATED PATENT APPLICATION(S)

The present disclosure is part of a non-provisional application claiming the priority benefit of India application No. 202321034104, filed 15 May 2023, the content of which herein being incorporated by reference in its entirety.

### TECHNICAL FIELD

The present disclosure is generally related to mobile communications and, more particularly, to enhancements of manual network selection in emergency services handling.

### BACKGROUND

Unless otherwise indicated herein, approaches described in this section are not prior art to the claims listed below and are not admitted as prior art by inclusion in this section.

A public land mobile network (PLMN) is a network established and operated by an administration or recognized operating agency (ROA) for the specific purpose of providing land mobile communication services to the public. One PLMN may include multiple radio access networks (RANs) utilizing different radio access technologies (RATs) for accessing mobile services. RAN is part of a mobile communication system, which implements a radio access technology. Conceptually, RAN resides between a mobile device and provides connection with its core network (CN). Depending on the 3^{rd} Generation Partnership Project (3GPP) standards, mobile phones and other mobile devices are varyingly known as user equipment (UE), terminal equipment (TE), mobile stations (MS), or mobile termination (MT), etc. Examples of different RATs include 2^{nd} generation (2G) Global System for Mobile Communications (GSM), 3^{rd} generation (3G) Universal Mobile Telecommunications System (UMTS), 4^{th} generation (4G) Long Term Evolution (LTE), 5th generation (5G) New Radio (NR).

In 3GPP, a network selection procedure (also called PLMN selection procedure) is defined for a UE to access PLMN services, and there are two modes of network selection, including automatic network selection and manual network selection. In automatic network selection, the UE selects and attempts registration on a PLMN based on a predefined rule which generally gives priority to the home PLMN (HPLMN) or an equivalent HPLMN (EHPLMN). In manual network selection, the UE typically camps on whatever PLMN that user selected and the UE should not automatically register on a different PLMN. However, according to current 3GPP standards, there are certain conditions where the UE behavior is undefined regarding whether manual network selection is allowed to be performed or not. For example, if a UE is involved in an attempting process to obtain emergency services on PLMN A when the user has selected PLMN B in the manual network selection mode, then the emergency services attempt may fail due to the manual selection of PLMN B which in the worst case may not support emergency services or emergency-service-related functionalities (e.g., emergency services fallback). As a result, the UE may be stuck in the network that does not support emergency services, i.e., the emergency services may be hindered or delayed, which is detrimental to user experience or even user's wellbeing.

Therefore, there is a need to provide proper schemes and designs to solve this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to emergency services handling in manual network selection mode.

In one aspect, a method may involve an apparatus determining whether the apparatus is in a condition of having an ongoing emergency service or attempting to obtain emergency services before an association between the apparatus and a core network of a wireless network for the emergency services is established. The method may also involve the apparatus determining not to perform a manual network selection in an event that the apparatus is in the condition of having the ongoing emergency service or attempting to obtain the emergency services before the association between the apparatus and the core network is established.

In one aspect, an apparatus may comprise a transceiver which, during operation, wirelessly communicates with a wireless network. The apparatus may also comprise a processor communicatively coupled to the transceiver. The processor, during operation, may perform operations comprising determining whether the apparatus is in a condition of having an ongoing emergency service or attempting to obtain emergency services before an association between the apparatus and a core network of the wireless network for the emergency services is established. The processor may also perform operations comprising determining not to perform a manual network selection in an event that the apparatus is in the condition of having the ongoing emergency service or attempting to obtain the emergency services before the association between the apparatus and the core network is established.

It is noteworthy that, although description provided herein may be in the context of certain radio access technologies, networks and network topologies such as LTE, LTE-Advanced, LTE-Advanced Pro, 5G, NR, Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of manual network selection mode procedure in accordance with an implementation of the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements of manual network selection in emergency services handling. According to the present disclosure, a number of possible solutions may be implemented separately or jointly. That is, although these possible solutions may be described below separately, two or more of these possible solutions may be implemented in one combination or another.

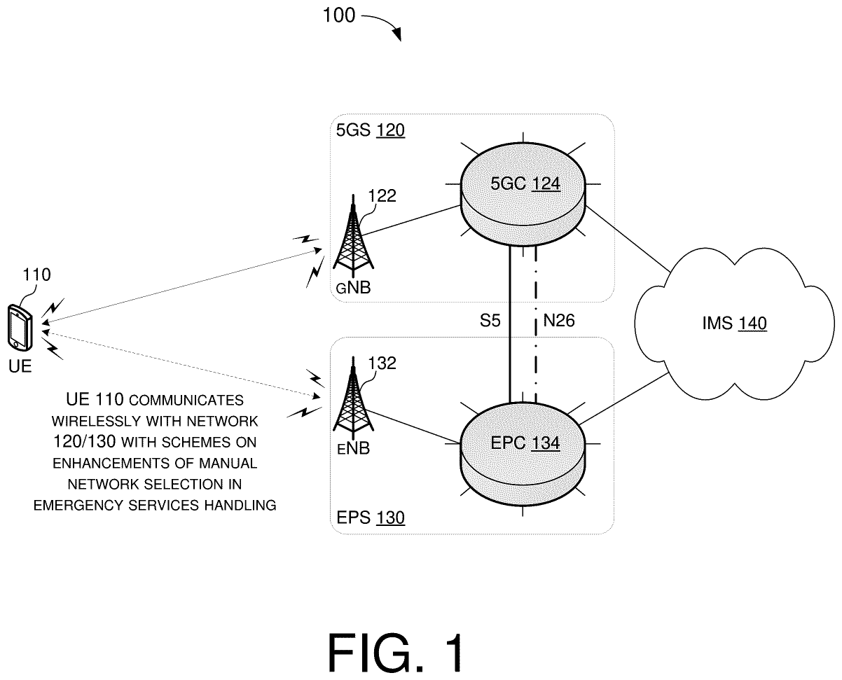

FIG. 1 illustrates an example scenario 100 of a communication environment in which various solutions and schemes in accordance with the present disclosure may be implemented. Scenario 100 involves a UE 110 in wireless communication with either one or both of a wireless network 120 (e.g., a 5G system (5GS) including a Next Generation Node-B (gNB) 122 and a 5G core (5GC) 124) and a wireless network 130 (e.g., an evolved packet system (EPS) including an evolved Node-B (eNB) 132 and an evolved packet core (EPC) 134). The wireless networks 120 and 130 may belong to the same PLMN or different PLMNs. Interworking between the 5GC 124 and the EPC 134 may be supported through an N26 interface and/or an S5 interface, where the N26 interface connects the core network nodes, e.g., 4G's mobility management entity (MME) and 5G's access and mobility management function (AMF), to allow them to coordinate the UE's mobility management, and the S5 interface connects the core network nodes, e.g., 4G's serving gateway (SGW) and 5G's packet gateway (PGW), to coordinate the UE's data connectivity. Each of the wireless networks 120 and 130 may further connect to an internet protocol (IP) multimedia subsystem (IMS) 140 which is responsible for delivering IP multimedia services, including voice call services (e.g., voice over IP (VOIP), voice over LTE (VOLTE), and voice over NR (VoNR)) and emergency services (e.g., circuit-switched (CS) emergency call, emergency bearer services, etc.). To support various deployment scenarios for obtaining emergency services, the UE 110 and the 5GC 124 may support the mechanism to direct or redirect the UE 110 either towards evolved universal terrestrial radio access (E-UTRA) connected to the 5GC 124 (i.e., RAT fallback) when only the NR BS (e.g., the gNB 122) does not support emergency services or towards the EPS 130 (i.e., system fallback) when the 5GC 124 does not support emergency services. The emergency services fallback may be used when the 5GS 120 does not indicate support for emergency services and indicates support for emergency services fallback. More specifically, in such communication environment, the UE 110 may implement various schemes pertaining to enhancements of manual network selection in emergency services handling in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In current 3GPP standards, there are certain conditions where the UE/MS behavior is undefined regarding whether manual network selection is allowed to be performed or not. For example, if a UE is involved in an attempting process to obtain emergency services on PLMN A when the user has selected PLMN B in the manual network selection mode, then the emergency services attempt may fail due to the manual selection of PLMN B which in the worst case may not support emergency services or emergency-service-related functionalities (e.g., emergency services fallback). Consequently, the UE may be stuck in the network that does not support emergency services, i.e., the emergency services may be hindered or delayed, which is detrimental to user experience or even user's wellbeing.

In view of the above, the present disclosure proposes a number of schemes pertaining to enhancements of manual network selection in emergency services handling. According to the schemes of the present disclosure, a UE may determine whether it is in a condition of having an ongoing emergency service or attempting to obtain emergency services before an association between the UE and a core network of a wireless network for the emergency services is established. Then, the UE may determine not to perform a manual network selection in an event that the UE is in the condition of having the ongoing emergency service or attempting to obtain the emergency services before the association between the UE and the core network is established. Additionally, or optionally, the UE may continue the attempting to obtain the emergency services. Accordingly, by applying the schemes of the present disclosure, the processes related to emergency services may continue without being interrupted by manual network selection, allowing the UE to obtain emergency services for user as soon as possible.

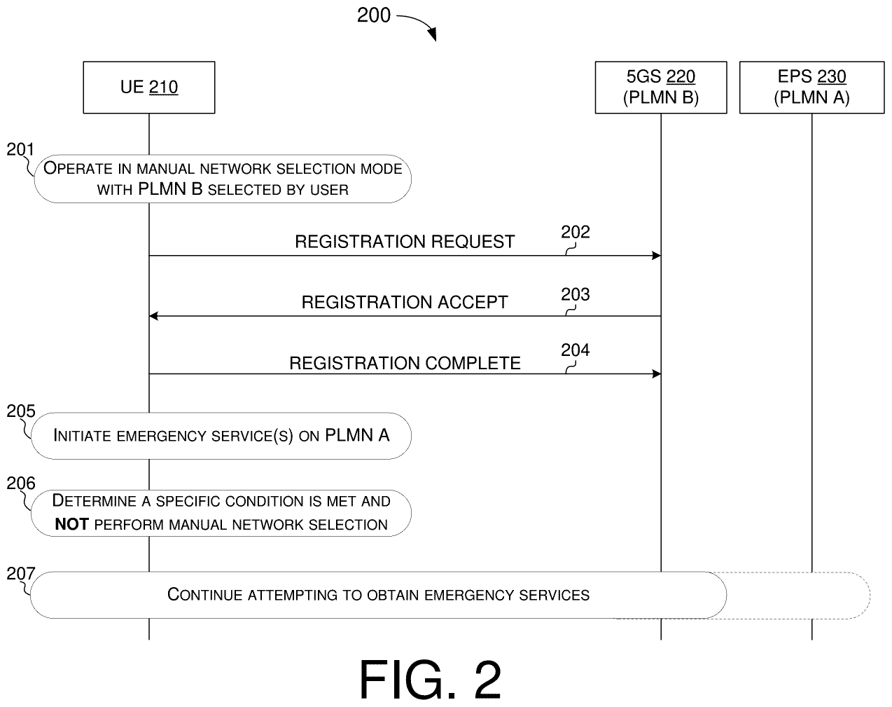

FIG. 2 illustrates an example scenario 200 of manual network selection mode procedure in accordance with an implementation of the present disclosure. Scenario 200 involves a UE 210 in wireless communication with a 5GS 220 of a first PLMN (denoted as PLMN B) and/or an EPS 230 of a second PLMN (denoted as PLMN A). In step 201, the UE 210 is switched on and configured to operate in the manual network selection mode with PLMN B being selected by user. In step 202, the UE 210 initiates a registration procedure with the 5GS 220 by transmitting a REGISTRATION REQUEST message to the 5GS 220. In step 203, the 5GS 220 accepts the UE's registration request by transmitting a REGISTRATION ACCEPT message to the UE 210. In one example, within the REGISTRATION ACCEPT message, the 5GS 220 may include an indication of support for emergency services fallback. In step 204, the UE 210 replies to the 5GS 220 with a REGISTRATION COMPLETE message, and the registration procedure is completed successfully. As that, the UE 210 is registered with the 5GS 220 of PLMN B.

Subsequently, in step 205, the UE 210 (automatically) initiates emergency service(s) on a different PLMN (e.g., PLMN A). In step 206, responsive to the initiation of emergency service(s), the UE 210 determines that a specific condition is met and then determines not to perform manual network selection (i.e., ignores/disregards the restriction in manual network selection mode that the UE should not automatically register on a different PLMN). In step 207, the UE 210 continues attempting to obtain emergency services on PLMN A.

Specifically, the condition may indicate that the UE 210 is having an ongoing emergency service (e.g., CS emergency fallback procedure is ongoing, or CS emergency call is pending or ongoing). That is, the UE 210 under the specific condition already has a PDN connection for emergency services. Alternatively, the condition may indicate that the UE 210 is attempting to obtain emergency services before an association (e.g., a packet data unit (PDU) session) between the UE 210 and the 5GC of the 5GS 220 for the emergency services is established. That is, the UE 210 under the specific condition does not have a PDU session for emergency services. Alternatively, the association may refer to a packet data network (PDN) connection if the UE 210 is currently registered with an EPS, or a packet data protocol (PDP) context if the UE 210 is currently registered with a 2G/3G/4G network.

In one example, the specific condition may indicate that the UE 210 is having an ongoing emergency services fallback procedure or is establishing emergency services fallback procedure (e.g., the UE 210 may have sent a SERVICE REQUEST message with a service type set to “emergency services fallback”). In another example, the specific condition may indicate that the UE 210 is being registered for emergency services (e.g., the previously sent REGISTRATION REQUEST message may include a 5GS registration type set to “emergency registration”). In another example, the specific condition may indicate that the UE 210 is establishing a PDU session for emergency services, a PDN connection for emergency bearer services, or a PDP context for emergency bearer services or CS emergency call.

In some implementations, the manual network selection may be delayed until the ongoing emergency services fallback procedure is completed. That is, the UE 210 may perform the manual network selection when the ongoing emergency services fallback procedure is completed. Alternatively, in another example, if the specific condition is met, the UE 210 may determine to abort the attempt to obtain emergency services and inform upper layers for the failure of the emergency service attempt.

In some implementations, the UE 210 may switch from N1 mode to S1 mode during the ongoing emergency services fallback procedure. Specifically, the N1 mode refers to a standalone mode allowing the UE to access the 5GC via the 5G access network (e.g., gNB), while the S1 mode refers to a non-standalone mode allowing the UE to access the EPC via the 5G access network.

Alternatively, in step 206, the UE 210 may determine to perform the manual network selection if the specific condition is not met (i.e., the UE 210 is not in the condition of attempting to obtain the emergency services before the association between the UE 210 and the 5GC is established).

### Illustrative Implementations

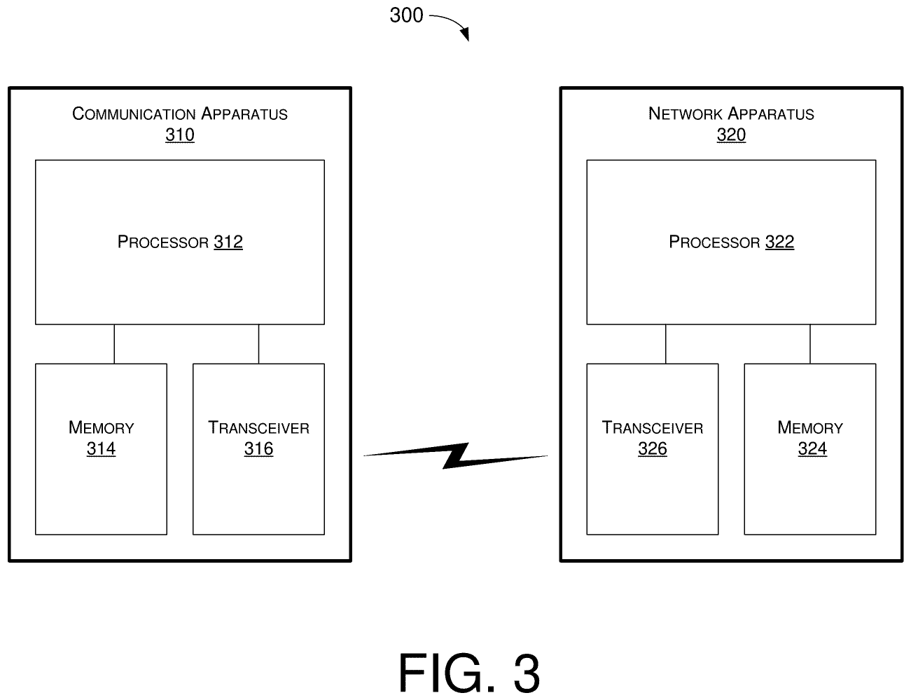

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to enhancements of manual network selection in emergency services handling, including scenarios/schemes described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 310 may also be a part of a machine type apparatus, which may be an IoT, NB-IoT, IIoT, BL, or CE UE such as an immobile or a stationary apparatus, a home apparatus, a roadside unit (RSU), a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a BS (e.g., an eNB, a gNB, or a TRP), a small cell, a router or a gateway of a wireless network (e.g., a 4G/5G/B5G/6G network), connecting communication apparatus 310 to the core network (e.g., an EPC or a 5GC) of the wireless network. For instance, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks, including enhancements of manual network selection in emergency services handling, in a UE (e.g., as represented by communication apparatus 310) and a network node (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, transceiver 316 may be capable of wirelessly communicating with different types of UEs and/or wireless networks of different RATs, e.g., 2G GSM, 3G UMTS, 4G LTE, 5G NR, and/or 6G. In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, network apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, communication apparatus 310 may further include a memory 314 coupled to processor 312 and capable of being accessed by processor 312 and storing data therein. In some implementations, network apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 310 and network apparatus 320 may be a communication entity capable of communicating with each other using various proposed schemes in accordance with the present disclosure. For illustrative purposes and without limitation, a description of capabilities of communication apparatus 310, as a UE is provided below.

Under certain proposed schemes in accordance with the present disclosure with respect to enhancements of manual network selection in emergency services handling, processor 312 of communication apparatus 310 may determine whether communication apparatus 310 is in a condition of having an ongoing emergency service or attempting to obtain emergency services before an association between communication apparatus 310 and a core network of a wireless network for the emergency services is established. Then, processor 312 may determine not to perform a manual network selection in an event that communication apparatus 310 is in the condition of having the ongoing emergency service or attempting to obtain the emergency services before the association between communication apparatus 310 and the core network is established. Additionally, or optionally, processor 312 may continue the attempting to obtain the emergency services.

In some implementations, processor 312 may also operate in a manual network selection mode.

In some implementations, processor 312 may also receive an indication of a selected PLMN (e.g., from user), and initiate a registration procedure on the selected PLMN.

In some implementations, the condition may indicate that communication apparatus 310 is having an ongoing emergency services fallback procedure.

In some implementations, the condition may indicate that communication apparatus 310 is being registered for the emergency services.

In some implementations, the association between communication apparatus 310 and the core network for the emergency services may include one of the following: (i) a PDU session for emergency services; (ii) a PDN connection for emergency bearer services; and (iii) a PDP context for emergency bearer services or CS emergency call.

In some implementations, the condition may indicate that communication apparatus 310 is establishing the PDU session for emergency services, the PDN connection for emergency bearer services, or the PDP context for emergency bearer services or CS emergency call.

In some implementations, processor 312 may also perform the manual network selection in an event that the ongoing emergency services fallback procedure is completed.

In some implementations, processor 312 may also switch from a first mode to a second mode during the ongoing emergency services fallback procedure, wherein the first mode allows communication apparatus 310 to access the core network using an advanced RAT (e.g., 5G), and the second mode allows communication apparatus 310 to access another core network using a legacy RAT (e.g., 4G).

In some implementations, processor 312 may also determine to perform the manual network selection in an event that communication apparatus 310 is not in the condition of having the ongoing emergency service or attempting to obtain the emergency services before the association between communication apparatus 310 and the core network is established.

### Illustrative Processes

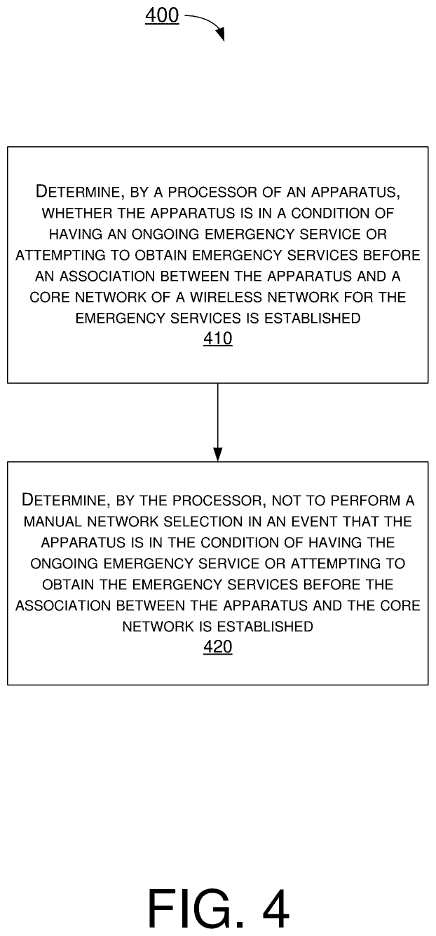

FIG. 4 illustrates an example process 400 in accordance with an implementation of the present disclosure. Process 400 may be an example implementation of above scenarios/schemes, whether partially or completely, with respect to enhancements of manual network selection in emergency services handling. Process 400 may represent an aspect of implementation of features of communication apparatus 310. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by or in communication apparatus 310 or any suitable UE or machine type devices. Solely for illustrative purposes and without limitation, process 400 is described below in the context of communication apparatus 310 as a UE. Process 400 may begin at block 410.

At 410, process 400 may involve processor 312 of communication apparatus 310 determining whether communication apparatus 310 is in a condition of having an ongoing emergency service or attempting to obtain emergency services before an association between communication apparatus 310 and a core network of a wireless network for the emergency services is established. Process 400 may proceed from 410 to 420.

At 420, process 400 may involve processor 312 determining not to perform a manual network selection in an event that communication apparatus 310 is in the condition of having the ongoing emergency service or attempting to obtain the emergency services before the association between communication apparatus 310 and the core network is established.

In some implementations, process 400 may further involve processor 312 operating in a manual network selection mode.

In some implementations, process 400 may further involve processor 312 receiving an indication of a selected PLMN (e.g., from user), and initiating a registration procedure on the selected PLMN.

In some implementations, the condition may indicate that communication apparatus 310 is having an ongoing emergency services fallback procedure.

In some implementations, the condition may indicate that communication apparatus 310 is being registered for the emergency services.

In some implementations, the association between communication apparatus 310 and the core network for the emergency services may include one of the following: (i) a PDU session for emergency services; (ii) a PDN connection for emergency bearer services; and (iii) a PDP context for emergency bearer services or CS emergency call.

In some implementations, the condition may indicate that communication apparatus 310 is establishing the PDU session for emergency services, the PDN connection for emergency bearer services, or the PDP context for emergency bearer services or CS emergency call.

In some implementations, process 400 may further involve processor 312 performing the manual network selection in an event that the ongoing emergency services fallback procedure is completed.

In some implementations, process 400 may further involve processor 312 switching from a first mode to a second mode during the ongoing emergency services fallback procedure, wherein the first mode allows communication apparatus 310 to access the core network using an advanced RAT (e.g., 5G), and the second mode allows communication apparatus 310 to access another core network using a legacy RAT (e.g., 4G).

In some implementations, process 400 may further involve processor 312 determining to perform the manual network selection in an event that communication apparatus 310 is not in the condition of having the ongoing emergency service or attempting to obtain the emergency services before the association between communication apparatus 310 and the core network is established.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, whether the apparatus is in a condition of having an ongoing emergency service or attempting to obtain emergency services before an association between the apparatus and a core network of a wireless network for the emergency services is established; and
determining, by the processor, not to perform a manual network selection in an event that the apparatus is in the condition of having the ongoing emergency service or attempting to obtain the emergency services before the association between the apparatus and the core network is established.

2. The method of claim 1, further comprising:
operating, by the processor, in a manual network selection mode.

3. The method of claim 2, further comprising:
receiving, by the processor, an indication of a selected public land mobile network (PLMN); and
initiating, by the processor, a registration procedure on the selected PLMN.

4. The method of claim 1, wherein the condition indicates that the apparatus is having an ongoing emergency services fallback procedure.

5. The method of claim 1, wherein the condition indicates that the apparatus is being registered for the emergency services.

6. The method of claim 1, wherein the association between the apparatus and the core network for the emergency services comprises one of the following:
a packet data unit (PDU) session for emergency services;
a packet data network (PDN) connection for emergency bearer services; and
a packet data protocol (PDP) context for emergency bearer services or circuit-switched (CS) emergency call.

7. The method of claim 6, wherein the condition indicates that the apparatus is establishing the PDU session for emergency services, the PDN connection for emergency bearer services, or the PDP context for emergency bearer services or CS emergency call.

8. The method of claim 4, further comprising:
performing, by the processor, the manual network selection in an event that the ongoing emergency services fallback procedure is completed.

9. The method of claim 4, further comprising:
switching, by the processor, from a first mode to a second mode during the ongoing emergency services fallback procedure, wherein the first mode allows the apparatus to access the core network using an advanced radio access technology (RAT), and the second mode allows the apparatus to access another core network using a legacy RAT.

10. The method of claim 1, further comprising:
determining, by the processor, to perform the manual network selection in an event that the apparatus is not in the condition of having the ongoing emergency service or attempting to obtain the emergency services before the association between the apparatus and the core network is established.

11. An apparatus, comprising:
a transceiver which, during operation, wirelessly communicates with a wireless network; and
a processor communicatively coupled to the transceiver such that, during operation, the processor performs operations comprising:
determining whether the apparatus is in a condition of having an ongoing emergency service or attempting to obtain emergency services before an association between the apparatus and a core network of the wireless network for the emergency services is established; and
determining not to perform a manual network selection in an event that the apparatus is in the condition of having the ongoing emergency service or attempting to obtain the emergency services before the association between the apparatus and the core network is established.

12. The apparatus of claim 11, wherein, during operation, the processor further performs operations comprising:
operating in a manual network selection mode.

13. The apparatus of claim 12, wherein, during operation, the processor further performs operations comprising:
receiving an indication of a selected public land mobile network (PLMN); and
initiating a registration procedure on the selected PLMN.

14. The apparatus of claim 11, wherein the condition indicates that the apparatus is having an ongoing emergency services fallback procedure.

15. The apparatus of claim 11, wherein the condition indicates that the apparatus is being registered for the emergency services.

16. The apparatus of claim 11, wherein the association between the apparatus and the core network for the emergency services comprises one of the following:
a packet data unit (PDU) session for emergency services;
a packet data network (PDN) connection for emergency bearer services; and
a packet data protocol (PDP) context for emergency bearer services or circuit-switched (CS) emergency call.

17. The apparatus of claim 16, wherein the condition indicates that the apparatus is establishing the PDU session for emergency services, the PDN connection for emergency bearer services, or the PDP context for emergency bearer services or CS emergency call.

18. The apparatus of claim 14, wherein, during operation, the processor further performs operations comprising:
performing the manual network selection in an event that the ongoing emergency services fallback procedure is completed.

19. The apparatus of claim 14, wherein, during operation, the processor further performs operations comprising:
switching from a first mode to a second mode during the ongoing emergency services fallback procedure, wherein the first mode allows the apparatus to access the core network using an advanced radio access technology (RAT), and the second mode allows the apparatus to access another core network using a legacy RAT.

20. The apparatus of claim 11, wherein, during operation, the processor further performs operations comprising:
determining to perform the manual network selection in an event that the apparatus is not in the condition of having the ongoing emergency service or attempting to obtain the emergency services before the association between the apparatus and the core network is established.
